(19) United States
(12) Patent Application Publication
(10) Pub. No.: US 2004/0015619 A1
(43) Pub. Date: Jan. 22, 2004

(54) Method and system for monitoring the status and operation of devices from a central location

(75) Inventors: William A. Brown, Raleigh, NC (US); Richard William Muirhead, Tyler, TX (US); Francis Xavier Reddington, Sarasota, FL (US)

Correspondence Address: Darcell Walker, 9301 Southwest Freeway, Suite 250, Houston, TX, 77074, US

(73) Assignee: INTERNATIONAL BUSINESS MACHINES CORPORATION, ARMONK, NY

(21) Appl. No.: 10/199,244

(22) Filed: Jul. 18, 2002

(51) Int. Cl. G06F 3/00

(52) U.S. Cl. 710/19

(57) ABSTRACT

The present invention provides a method and system to monitor the statuses of devices that operate in a network environment such as a physical facility from a central location. In this system, there is a repository of the status of all designated device attributes of a device including the past state history of the device. Each device on the system will transmit a state change notification to the central location each time the status of the device changes. This status change will be recorded in the storage location. The implementation of a centralized configuration also provides each device, product and smart application a common interface to use to transmit messages or information to other devices in the same facility of devices that are connected to the same central location. It also enables devices to recover to a previous state or reset devices to a present state in the event of a power outage.

### FIELD OF THE INVENTION

This invention relates to a method and system for monitoring the activity of devices and in particular to a method and system for monitoring and storing the operational statuses of devices in a network type environment such as a physical facility and recording any change in the status of a device.

### BACKGROUND OF THE INVENTION

Automation systems are used to control the behavior of an environment such as an industrial plant, an office building or a residential dwelling. Currently there is an increasing trend to automate various activities and task in our society. Industries such as the banking industry, the automotive industry, the oil and refining industry and transportation industry use computers and automation to control machines and other various devices during the performance of many tasks and processes. The application of automation control systems has expanded from large industries to small businesses and residential homes.

Home automation systems, or home management systems as they are sometimes called, commonly provide for control of lighting, heating and air conditioning, window shades or curtains, pool heaters and filtration systems, lawn sprinklers, ornamental fountains, audio/visual equipment, and other appliances. Home automation systems are frequently integrated with a home security system so that when a fire alarm is raised, for example, internal and external lights will be turned on. Security systems frequently include lighting control and other types of home automation as an option. Many larger homes incorporate a home theater that requires a certain amount of automation for convenient operation and this automation is often extended to other parts of the dwelling. In farms, the automation system will also control outbuilding heating and lighting and warn of abnormal conditions in automated feeding machinery and other equipment.

One form of automation system includes a central control unit that monitors environmental sensors and inputs from user controls and maintains a schedule of preprogrammed time-of-day and day-of-the week events. Inputs to the central control are provided by dedicated low-voltage wiring, for example, from door and window sensors, signals carried on power lines, RF signals, signals on existing telephone wiring and, occasionally, optical signals. The central control unit is controlled by a program that is either specifically built for the particular installation or a general-purpose program with a user interface that allows the owner or a technician employed by the owner to make certain types of modifications. The interfaces to these programs can be anything from strings of digits entered on standard touch-tone keypads, for example, Home Automation Inc.'s Omni Automation and Security System, to graphical user interfaces, for example, the Molex “Choices” software.

The communication between the central control unit and various devices can be through a variety of protocols. The Echelon Corporation has built home automation and industrial control apparatus based on a signaling protocol they refer to as LonWorks that uses a network of nodes each of which has one or more microprocessors. The system is designed to operate in a “cooperative computing” environment in which the individual nodes maintain their own programs. Programming of the individual nodes can be done by downloading new software from a temporarily attached lap top computer or by downloading software over the LonWorks network. A similar approach has been taken by CEBus and has been used in many custom installations for larger homes and office buildings. While such systems eliminate the central control unit, modifying the software still requires the use of a PC-based system and usually requires the user to acquire relatively expensive hardware and software and become proficient in the use of PC-based software.

The latest internationally accepted standard for residential communication is the Consumer Electronics Bus (CEBus). The Media used in a CEBus Network topology can vary between power-line wiring (PL), telephone wiring (TP twisted-pair), coaxial cable (CX), RF (radio frequency) and the like. It provides the standard for creating products and devices to communicate with each other, and should build intelligence into homes or any physical or virtual facility with smart products (aggregation of smart devices) in anticipating tomorrow's consumer needs. Though the intent of the original specification was directed at the residential market, the inventions disclosed here by its three inventors have envisioned a much more extensive application uses. The consumer can be any person, a firm, government agency, whatever or whomever has a need to communicate to smart devices.

The official name for CEBus standard is ANSI/EIA 600. At the core of the standard are the CAL (Common Application Language) and the Application Layer. It provides the basis of the interoperability between CEBus compliant devices and a transport independent version (Generic CAL) (Generic CAL) ANSI/739 that an integral part of the Home PnP (Plug and Play) ANSI/721 specification (which defines how networked products of various manufactures achieve interoperability regardless of the communication protocol used (CEBus, X-10, RS-232, IEEE-1934, TCP/IP etc.)

The devices that utilize these standards contain context data structures. Each CAL Context is a predefined data structure built from reusable objects, and represents a common consumer product function such as a tuner, time or temperature sensor. These context data structures are defined in a set of subsystems definitions that represent industry standard guidelines that define the behavior of the device, which is necessary to enable products to correctly use the subsystem models.

In a home, there are many appliances/devices that are powered by electricity, either AC or DC. At the present time, these devices do not have the ability to communicate with each other. In addition, there is no standard method to keep track of the current state of each device. The state attributes could be for example ‘on’, ‘off’, ‘channel’, ‘temperature’ etc. Currently some devices have a means to report information back to the manufacturer of the device activities of the device through proprietary channels, however there is no way currently for the various devices to communicate with each and no way for the homeowner to receive this type of status information. In addition, a homeowner or facility owner does not have a way to control these devices or know the identity of those having access to these devices.

Electronic devices traditionally have two states either on or off. Today, with the use of Context data structures embedded within a device, non-persistent property characteristics are stored within the device. This property data is overwritten as changes to the device occur. Storage of this information outside this limited capacity of the device is necessary for any applied application.

It is desirable to provide an automation system that has a central control unit that can enable various devices on the same system to communicate with each other. In addition it is desirable to have a standard method to keep track of the current and past states of each device on the system. It is another desire to have a system when the homeowner or facility owner can have access to and control these devices. In addition to these desires, it is also desirable to provide an automation system that is inexpensive, easily installed, easily programmable and reprogrammable. It is also desirable to provide an automation system that allows the incorporation of new and different, appliances and controllers without the system becoming obsolete.

### SUMMARY OF THE INVENTION

It is an objective of the present invention to provide a method and system to monitor the status of devices from a central location.

It is a second objective of the present invention to provide a central location that will store the status each device.

It is a third objective of the present invention to create and maintain a history of the activity of a device through the recording of the status history of the device.

It is a fourth objective of the present invention to provide a method by which each device would transmit to the storage location a new status whenever there was a change in status of the device.

It is a fifth objective of the present invention to provide method to display the status history of a device in response to an inquiry.

It is a sixth objective of the present invention to provide a method and system that will enable devices which transmit information on different communication protocols to communicate with the storage location using a common format.

It is a seventh objective of the present invention to provide an automated system in which the devices in the system can communicate with each other.

It is an eighth objective of the present invention to provide a method and an automated system by which the facility owner can access a device's status and control devices on the system.

The present invention provides a method and system to monitor and manage the statuses of devices from a central location. The state management process produces and stores in a repository a record of the statuses of all device attributes over a period of time and thereby generating for each device a state history. This repository of information enables devices, products and smart applications to inquire and use any derived intelligence from a common interface. The state management process enables these devices, products and smart applications to apply this acquired information, achieve interoperability, and to recover to a previous state or reset to present state in the event of a power outage, or other unscheduled event.

Electronic devices traditionally have two states either on or off. With the use of context data structures embedded within a device, it is possible to store property characteristics. However, currently, this property characteristic information is only available if the device is polled from another device. The present invention provides a repository of the present state of all device attributes and the state history of the device. This centralized configuration provides the device, products and smart applications a common interface to inquire and use any derived intelligence in applying this acquired information. It also enables devices to recover to a previous state or reset devices to a present state in the event of a power outage.

In this invention, each device in a facility communicates with a state manager process (also referred to herein as state manager). Associated this state manager is one or more storage locations that will store the identity of each device and the current and past statuses of the device. The status is any current state of a device and can have one general attribute or multiple attributes. An example of a device is a videocassette recorder. The status could be one attribute such as “off” and “on” or multiple attributes such as off, on, start, stop, rewind, record, pause, program or channel. For a multiple attribute device, a change in any attribute would constitute a change in the device status. When this change occurs, the device would transmit the status change to the state manager. This new change in status would be stored as the current status of the device. For each device, the storage location would contain a current status and a set of past statuses such that the owner of the facility or any authorized user could view the activity history of a device. The data storage location can also store messages that have been transmitted across the network. The storage configuration can be centralized or can have a distributed design with multiple storage sites.

In the method of the present invention, each new device to a facility system would be added to the state manager and would have device identification number. At this point, the state manger would transmit to and install a software routine on the device that would enable the device to asynchronously transmit to the state manager a status change each time a status change occurs within the device. A status change can be defined by a change in any one attribute or a combination of attributes. When a status change occurs in a device, that device would transmit the change to the state manager for recording and storage in the designated repository location for that device.

### BRIEF DESCRIPTION OF THE DRAWINGS

FIG. 1 is a configuration of components in a physical or virtual facility that implements the method and system of the present invention.

FIG. 2 represents the application of the present invention to a thermostat system.

FIG. 3 illustrates a state diagram showing the state management of a CAL message compliant device.

FIG. 4 is an illustration of a CEBus model.

FIGS. 5a, 5b and 5c are various implementations of the model in FIG. 4.

FIG. 6a is an illustration of the ISO model and CEBus model that represents a conventional standard of communication.

FIG. 6b shows the internal structure of the CEBus communication model.

FIG. 7 is a flow diagram of the steps in the method of the present invention.

FIG. 8 is an illustration of a storage configuration containing the devices and device statuses in accordance with the present invention.

### DETAILED DESCRIPTION OF THE INVENTION

The present invention provides a method and system to collect a unique set of data containing the statuses of attributes of a device over a period of time. In order to clearly illustrate the techniques in this invention, the description of this invention will be in the context of an application in a physical facility. However, the application of this invention encompasses applications in addition to the physical facility environment described herein. The present invention has the capability to monitor and manage the statuses of device, that operate in a physical facility, from a central location. The physical facility can vary and can be for example a business, a factory, a computing center, a distributed network of devices, or satellites orbiting in space. The implementation of the present invention does not need to be configured as a centralized control contained within a building structure. For example, the facility could be a home is using the latest internationally accepted standard for residential communication (which in this example is the Consumer Electronics Bus (CEBus)), In this home the designated state management repository will hold all state information of all compliant devices. For example, for a radio device, the processes in the state management system will capture data that comprise the present and past states of the radio, how long it has been on, its tuned broadcasting frequency, its volume level, the time it was tuned to that particular station, the station it was tuned to previously, and the time it was tuned to that previous station. For a different device, the system will also capture the status of the smoke detectors in the house, whether they are operable, if they need maintenance, when each detector was last activated, and the amount of time they were active. The state management system of the present invention can also capture anyone or any device attempting to gain electronic access to devices in this facility, the time of the attempted access, and the origin of this access attempt. This data can remain in the persistent store for the life of the device, the life of the home, or a predetermined time period established by the owner.

The communication with all compliant devices through the internetwork can use any or all of the following mediums; power-line wiring (PL), telephone wiring (TP twisted-pair), coaxial cable (CX), RF (radio frequency) and other similar transmission mediums. The present invention provides the standard for creating products and devices to communicate with each other, and build intelligence into homes or any physical or virtual facility with smart products (aggregation of smart devices) in anticipating the needs of tomorrow's consumer. The present invention has applications in various segments of society, which include individual consumers, a business, a firm, or governmental agency.

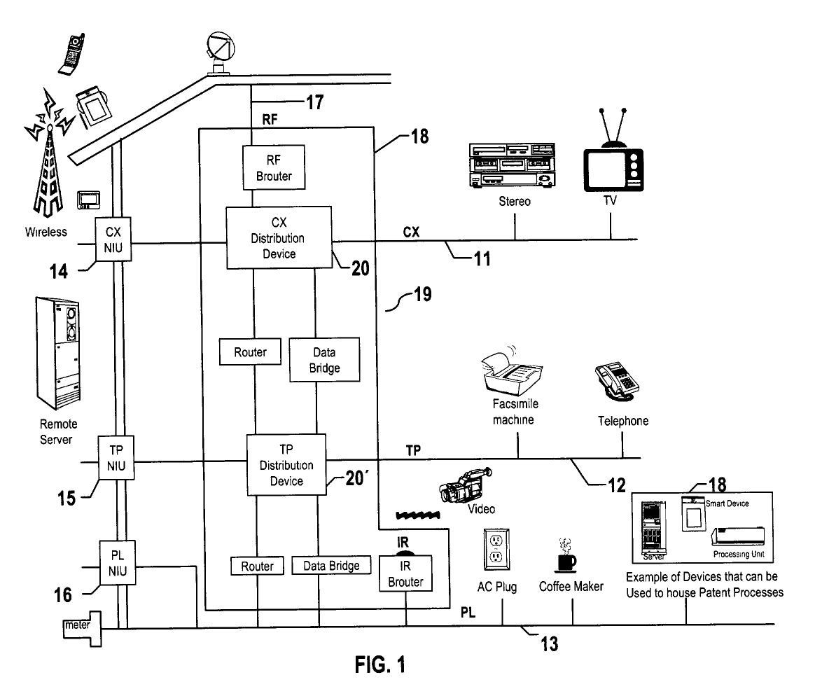

FIG. 1 is a configuration of components in the system of the present invention. In this configuration lines 11, 12 and 13 are various ways that information and energy can enter a facility to enable operations of the devices in the facility. Line 11 represents communications over a coaxial cable through a device such as a television set. Line 12 represents communications over twisted pair cables through a device such as a telephone. Line 13 represents the supply of energy through a standard power line wired into the facility to operate devices and appliances in the facility such as a coffee maker. These communication lines are physical and therefore have a physical entry into the facility. The physical entry points for the coaxial cable, twisted pair and power lines are represented by NIU boxes 14, 15, and 16 respectively. Also shown is an input medium using radio frequencies (RF) 17. Devices that communicate through this medium are remote devices/wireless devices that include devices such as cellular telephones. In the present invention, there would be a status of each device in facility regardless of the manner in which the device is powered or the manner in which the device communicates. The center of activity for the present invention is the state manager 18, which is a process that receives information from various types of devices. This state manager 18 captures status information for the various devices and coordinates communications between the various devices in the facility. In addition, this process, using industry standard format, provides persistence to a data store and can transmit data to any device in the facility. Section 19 illustrates bridges and routes that provides communication links between the incoming information lines (11, 12, and 13), the distribution devices 20 and 20′ and the devices.

As previously mentioned, the devices that utilize the CEBus standards contain context data structures. Each CAL Context is a predefined data structure built from reusable objects, and represents a common consumer product function such as a tuner, time or temperature sensor. These context data structures are defined in set of subsystems definitions that represent industry standard guidelines that define the behavior of the device. These guidelines are necessary to enable products to correctly use the subsystem models.

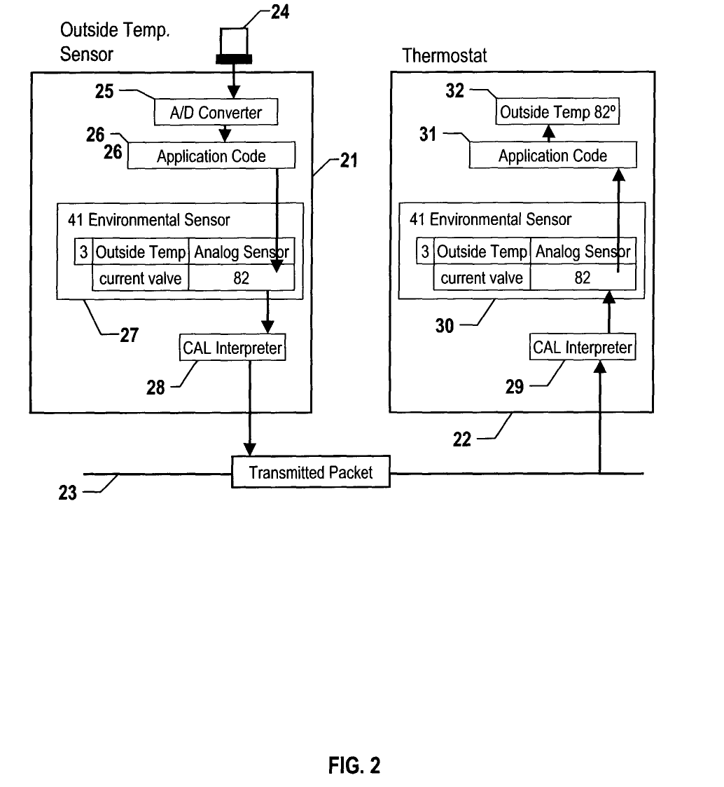

FIG. 2 shows two different devices that communicate with each other using this CEBus network topology standard. One device is an outside temperature sensor 21, the other being a thermostat 22. Both devices store within their solid-state memory context data structures, in which contain different attributes and their values. The sensor and thermostat can communicate with the state manager 18 over a transmission bus 23. The outside temperature system comprises an actual sensor 24 that detects the current outside temperature. This sensor sends an analog signal of the measured to temperature to an A/D converter 25 that converts the signal to digital form. The application code box 26 processes this signal and sends it to a display 27. This application code box 26 contains software that can exist on any device. The use of a Consumer Electronic Bus (CEBus) protocol allows for application software to reside on each device. Box 27 displays the current temperature measured by the sensor 24. The Common Application Language (CAL) interpreter 28 receives this measurement and transmits the information via the transmission bus 23 to the state manager process. The CAL interpreter parses and understands the message format and the transmitted packet represents a communication link between the two devices. This information would be recorded for the temperature sensor in the storage section each time the temperature sensor detected a change in temperature. The internal thermostat 22 contains a Common Application Language (CAL) interpreter 29 to facilitate communication via the transmission bus 23 with the state manager 18. Also contained in the thermostat is a temperature display 30 similar to the display 27 in the outside temperature sensor 21. Application code 31 puts the temperature information in a form for the temperature display 32. In accordance with the present invention, upon receiving the change in temperature notification from the temperature sensor, the state manager 18 can send a temperature change notification to the thermostat of the new sensed temperature. The thermostat can then adjust the room or facility based on the new sensed temperature. This thermostat changed will then be broadcast/sent to the state manager and recorded as a change in status of the thermostat.

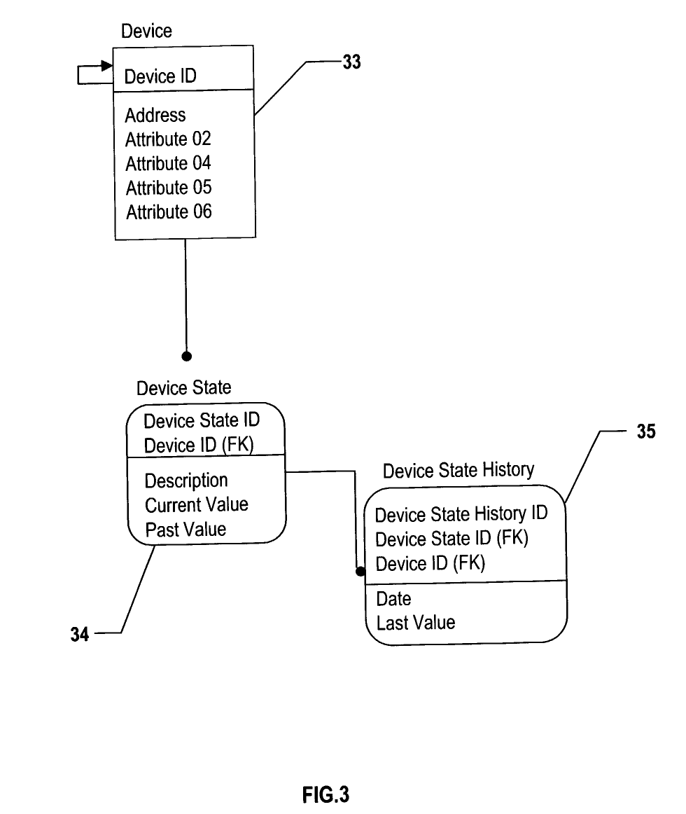

FIG. 3 illustrates a process and data flow model of a device state management system of the present invention. The process maintains state (status) information of all devices, sensor and components that it can communicate on the system. This model provides the basis and core of sub systems status (state), transition and event driven based decision-making operation. The process maintains current status of devices and it's past state history. It also offers the capacity to reset status in the event of an interruption in power or reversing an updating entry. The names chosen in this model exemplify distinctly what the process flow represents. Regardless, if the entities and its attributes are renamed or represented in a de-normalized fashion. The effect of the model is the same. The device 33 comprises attributes that define it current data values, and primary event driven operations. Devices can also be an aggregation of smaller devices (i.e. sensors, components, etc.) The device has a Unique Identifier and sensor(s) or component(s) that are aggregated make up that device [i.e. a thermal sensor, and a Thermostat (consists of thermal sensor, LED display etc.) are both considered devices. Though one attribute may be part of the composition of another.] The device state 34 represents current status configuration of the device. This device state comprises: 1) Device State ID—Unique identifier of the specific status state it references, 2) Description—Clear Definition of the State that is identified by the Device State ID, 3) Current Value—Current Status value of the device and 4) Past Value—Previous Status value of the device. The Device State History 35 contains the history of pass values per device which include: 1) Date Date of historical record and 2) Last Value—last value recorded on that date

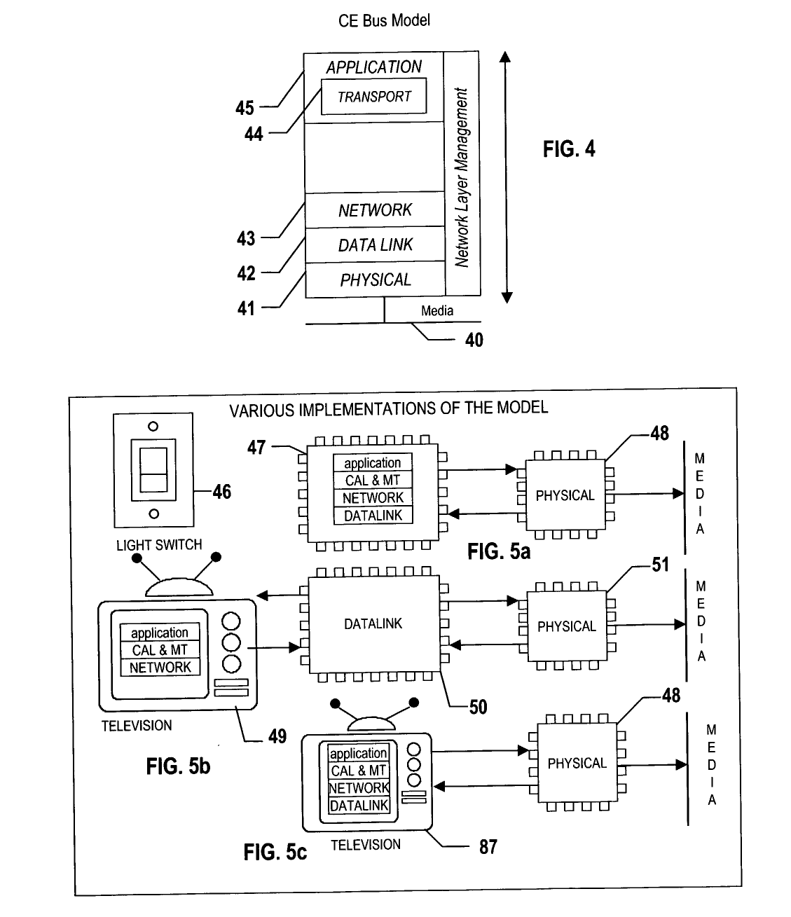

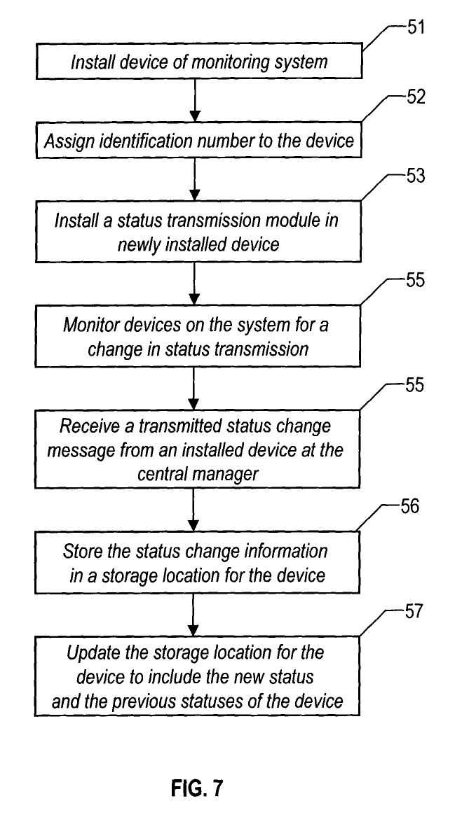

FIG. 4 is an illustration for the purpose of example of the Consumer Electronic Bus) CEBus Layered Model. It is a standard, much like the OSI (Open Systems Interconnection) Model, in that it illustrates the layer of communication from the physical layer (via physical connection to a media source) up the logical layers above the previous layer (via the network management) to the top level application layer into an application that makes sense of the information being transferred. Smart embedded devices in the Consumer Electronic Industry follow this standard. In fact many devices do not need to contain all logical levels within themselves within a single chip or component. The different required layers can span over components before the physical layer connects to a network medium. Various implementation of this is illustrated in FIG. 7.

At the core of the standard are the CAL and the Application Layer. It provides the basis of the interoperability between CEBus compliant devices and the transport independent version (Generic CAL0 ANSI/EIA 739 that is an integral part of the Home PnP (Plug and Play) ANSI/EIA 721 specification (which defines hoe networked products of various manufactures achieve interoperability regardless of the communication protocol used (CEBus, X-10, RS-232, IEEE-1394, TCP/IP etc.).

In this model, shown in FIG. 4, media 40 represents the wiring going out from the model. The physical layer 41 is the connection of a device to an electronic network. The data link layer 42, network layer 43, transport layer 44 and application layer 45 represent a standard of how information is communicated from a physical device down to logical data that is traced back to an application that talks to that model.

FIGS. 5a, 5b and 5c are various implementations of the model in FIG. 4. The FIG. 5a shows an implementation in a light switch 46. Within this light switch can be a circuit containing the model. The model in this configuration is implemented in multiple circuits 47 and 48. Circuit 47 contains the application, 45 transport (CAL &MT) 44, network 43 and data link layers 42. Circuit 48 contains the physical layer 41 that connects to the media. The various implementations are presented to show that as long as each layer is present, the model will work. Various implementations are necessary because manufactures may implement this model in different ways. Some manufactures may include some layers in the device that will require to inclusion of the remaining layers on at least one separate circuit. FIG. 5b is an alternate implementation of the model. In this implementation, a television 49 contains the application, CMT & MT, and network layers. The data link layer and physical layer are on separate circuits 50 and 51 respectively. FIG. 5c shows a device 52 containing the application, CAL & MT, network and physical layers. As with the other implementations, the physical layer resides on a separate circuit 48.

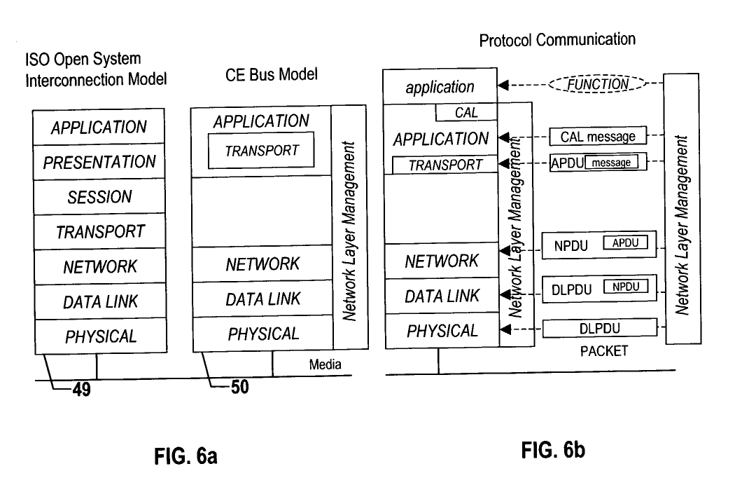

The state manager 18 can be maintained anywhere even remotely since the CEBus Model can share a common connection with the ISO across the same physical media. Regardless of the communication protocol used across the gateway, the receiving end needs only to understand the communication protocol and be able to interpret the data packets sent across the network. FIGS. 6a and 6b illustrate how communication can be bridged between the CEBus and the OSI Model, via a connected medium. The connected medium does not necessary have to be the same wire it can represent any other available connection means. These figures represent the two standard models interconnected, and communicating with each other. These models illustrate how far reaching the scope of the state management system of the present invention is, and that it can incorporate any device connected to the state manager 18. FIGS. 6a and 6b represent only two types of models, however there is an unlimited number of interconnected model designs that can implement the concept of the state manager described in this invention. The state manager can involve any interconnections that can be accomplished between different models and their supported interconnected networks, as long as communication is allowed to flow to the state manager 18 (model represented by FIG. 3).

As illustrated in FIG. 6a, the ISO System model 49 represents another conventional standard for communication. This model has seven different layers of communication. The CEBus model 50 has a different layer structure than the ISO model. However, down at the physical layer, the models are the same. The common physical layer provides the common interface for the models to communicate with each other through the media.

FIG. 6b shows the internal structure of the CEBus model. In this configuration information comes into the model through the different layers. The Common Application Language (CAL) is an interpreter that parses information and data containing status messages coming into the model to appropriate applications and enables those applications to use that data. This diagram shows how information can go from a physical to a logical type of interpretation.

FIG. 7 is a flow diagram of the steps in the method of the present invention. The initial step 51 is to install a new device on the status monitoring system. The installation requires connecting the device to a communication link such as coaxial cable or twisted pair cable. Also in this installation step, the state manager 18 sends notice of a new device. After this notice, in step 52, the central manger assigns an identification number to the device. In step 53, the state manager 18 transmits a status transmission model in the form of a software routine to the device that is automatically installed in the device. This model will access the attributes of the device and determine the various statuses and the criteria that will constitute a status change. These criteria can also be determined externally by a user and can override any criteria of the model. After the device installation phase, the state manager 18 is in a wait state for a change in status message from the device 54. The initial state of the device can be a default of “off”. When there is a change in the status of the device, the device will transmit a change in status message to the state management process as shown in step 55. This message should contain the particular attribute or set of attributes that changed status and the new status of the device. The state manager will identify the particular device and store this current status information in the location for that device in step 56. The state management process will also maintain the previous status of the device in the storage area for that device 57.

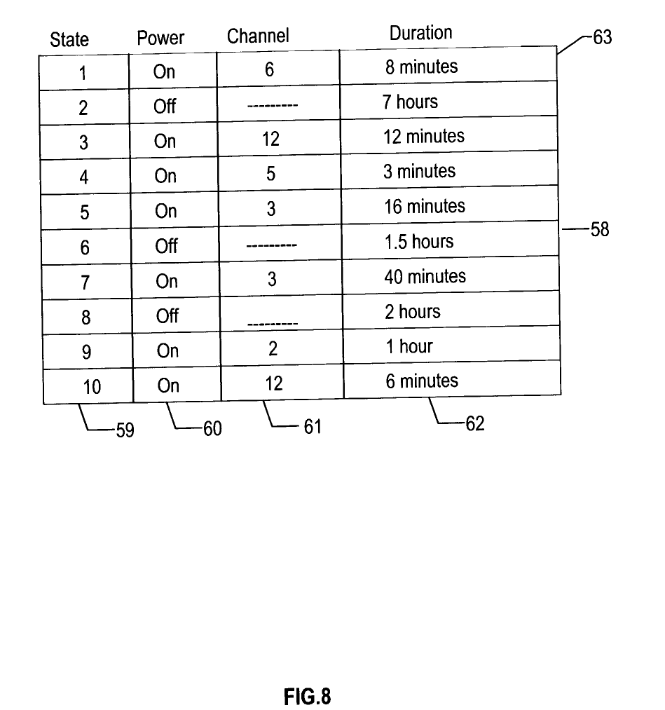

FIG. 8 is an illustration of a storage configuration containing the current and past statuses of a television device in accordance with the present invention. In this configuration 58, there are a total of 10 status entries. The first field 59 lists the number of each state. The second field 60 lists the current power status of the device. Field 61 is the channel of the television. The fourth field 62 is the duration of the particular status. In this example, the first record 63 is the current status of the device. The record shows that the current status of the device is “on” and set to channel 6. The device has been set to channel 6 for eight minutes. If the owner of the facility accesses the system and wants to view the television device, the system would display this status history. The information in the status history can display as many attributes as the owner desires with respect to the particular device. In addition, the status history can vary with respect to the number of status entries that are to be maintained for a device. For example, the status history may be maintained for only the current day.

State management can be kept virtually anywhere, within an application, embedded within a device that provides the connection a gateway on a traditional database application, within a server on the network of a traditional supported ISO Model, or on any smart device on the local network or through a connected gateway connection. This freedom, allows device status to be obtained from anywhere.

In addition, when a device is added to the interconnected networks, the state manager stores the current state of the devices attributes. When the status of the device changes, the changed attributes updated are reflected within the state management system. The previous record is then store in the devices state history. This provides devices, products and smart applications, a common interface to inquire and use any derived intelligence in applying this acquired information. It also enables connected devices to recover to a previous state or reset devices to present state in the event of a power outage.

The present invention provides a method and system to collect a unique set of data containing the operations of a device over a period of time. The nature of the application of the present invention is such that various configurations of this invention can be implemented under the same concept described herein. While the description herein is one embodiment of the invention, alternate embodiments can be designed by those skilled in the art that would also fall under the scope of the present invention. It is important to note that while the present invention has been described in the context of a fully functioning data communication system, those skilled in the art will appreciate that the processes of the present invention are capable of being distributed in the form of instructions in a computer readable medium and a variety of other forms, regardless of the particular type of medium used to carry out the distribution. Examples of computer readable media include media such as EPROM, ROM, tape, paper, floppy disc, hard disk drive, RAM, and CD-ROMs and transmission-type of media, such as digital and analog communications links.

We claim:

1. A method for monitoring the status of devices from a centralized location comprising the steps of:
installing a device on a monitoring system that has a centralized status manager and storage location, said device being one of a plurality of devices on the monitoring system;
receiving at the centralized manager a status change notification from one of the devices on the system;
identifying the specific device on the system that transmitted the status change notification; and
storing the status change information in the storage location for that specific device.

2. The method as described in claim 1 wherein said installation step further comprises the steps of identifying device attributes that will impact a change in the status of the device and creating a storage record for the device based on the identified device attributes.

3. The method as described in claim 2 further comprising after said installation step, the step of assigning to a newly installed device a device identification number.

4. The method as described in claim 1 further comprising the step of installing in the newly installed device a status transmission module to control the transmission of status change notifications to the state manager.

5. The method as described in claim 2 wherein a status change notification step further comprises the step of compiling the status change notification message, which will include the current status of each designated device attribute.

6. The method as described in claim 4 further comprising after said status module installation step, the step of waiting to receive a status change notification from a system device.

7. The method as described in claim 6 further comprising after said storing step the step of updating the presently stored status information for the device transmitting the status change notification.

8. The method as described in claim 7 wherein said stored status information comprises the past statuses of the device.

9. The method as described in claim 8 wherein said storing step comprises storing past statuses in a storage location in a chronological order.

10. The method as described in claim 9 further comprising the step of calculating the duration of each past status and storing the calculated duration in the storage location for that device.

11. A computer program product in a computer readable medium for monitoring the status of devices from a centralized location comprising:
instructions for installing a device on a monitoring system that has a centralized status manager and storage location, said device being one of a plurality of devices on the monitoring system;
instructions for receiving at the centralized manager a status change notification from one of the devices on the system;
instructions for identifying the specific device on the system that transmitted the status change notification; and
instructions for storing the status change information in the storage location for that specific device.

12. The computer program product as described in claim 11 wherein said installation instructions further comprise instructions for identifying device attributes that will impact a change in the status of the device and creating a storage record for the device based on the identified device attributes.

13. The computer program product as described in claim 12 further comprising after said installation instructions, instructions for assigning to a newly installed device a device identification number.

14. The computer program product as described in claim 11 further comprising instructions for installing in the newly installed device a status transmission module to control the transmission of status change notifications to the state manager.

15. The computer program product as described in claim 2 wherein a status change notification instructions further comprise instructions for compiling the status change notification message, which will include the current status of each designated device attribute.

16. The computer program product as described in claim 14 further comprising after said storing instructions, instructions for updating the presently stored status information for the device transmitting the status change notification.

17. The method as described in claim 16 wherein said storing instructions further comprise instructions for storing past statuses in a storage location in a chronological order.

18. The computer program product as described in claim 17 further comprising instructions for calculating the duration the of each past status and storing the calculated duration in the storage location for that device.

19. A system for monitoring the status of devices from a centralized location comprising:
a plurality of devices capable of operating in multiple states;
a centralized status monitor cable of receiving status information from said plurality of devices;
a centralized storage facility for storing status of the plurality of said plurality of devices;
a system of communication links to connect said plurality of devices to said centralized status monitor; and
a plurality of status notification modules to enable each of said plurality of devices to transmit a status change to said centralized status monitor.

20. The system as described in claim 19 wherein said centralized storage facility comprises a plurality of records, each of said records containing the statuses of a device from said plurality of devices.

21. The system as described in claim 20 wherein each said record contains fields for each attribute of a device that impacts the status of the device.

22. The system as described in claim 19 wherein said system of communication links is a communication network.

23. The system as described in claim 19 wherein said a centralized status monitor and said centralized storage facility are located at a remote location with reference to said plurality of devices.

24. The system as described in claim 20 where said centralized storage facility further comprises mechanisms to calculate and display the duration of a status on a particular device.
